(19) United States
(12) Patent Application Publication
(10) Pub. No.: US 2018/0193953 A1
(43) Pub. Date: Jul. 12, 2018

(54) MANUFACTURING METHOD AND APPARATUS

(71) Applicant: ROLLS-ROYCE plc, London (GB)

(72) Inventor: John H. BOSWELL, Derby (GB)

(73) Assignee: ROLLS-ROYCE plc, London (GB)

(21) Appl. No.: 15/861,906

(22) Filed: Jan. 4, 2018

(30) Foreign Application Priority Data
Jan. 6, 2017 (GB) 1700170.2

(51) Int. Cl. B23K 26/34; B23K 26/354; B22F 3/105; B33Y 10/00; B33Y 30/00

(52) U.S. Cl. CPC B23K 26/34; B23K 26/354; B33Y 30/00; B33Y 10/00; B22F 3/1055

(57) ABSTRACT

The present invention relates to a method of forming a three-dimensional component by additive layer manufacturing. The method comprises scanning a fusing energy beam having a fusing beam focus spot across a layer of powered material in a series of fusing scan lines to fuse the powder material to form a layer of fused material whilst scanning a heating energy beam having a heating beam focus spot in a series of heating scan lines across the material fused by the fusing energy beam. The centre of the fusing beam focus spot and the centre of the heating beam focus spot are off-set from one another and spaced by up to an amount equal to the sum of the radius (y) of the heating beam focus spot and two times the radius (x) of the fusing beam focus spot.

### CROSS-REFERENCE TO RELATED APPLICATION

This application is based upon and claims the benefit of priority from British Patent Application No. 1700170.2 filed 6 Jan. 2017, the entire contents of which are incorporated herein.

### BACKGROUND

### Field of the Invention

The present invention relates to an additive layer manufacturing method and apparatus for producing a three dimensional component. In particular, this invention relates to an additive layer manufacturing method for reducing cracking due to residual stress in the resulting component.

### Description of the Related Art

In the aerospace industry, components manufactured by additive layer manufacturing (ALM) methods can have significant performance and weight advantages over components manufactured by more traditional methods.

Powder bed ALM methods construct components layer by layer by depositing powder on a build plate (also known as a base plate) and then selectively consolidating or fusing the powder using a laser or other heat source, such as an electron beam. These steps are repeated to produce a three dimensional component layer upon layer.

FIG. 1 shows a side view of a standard single beam ALM system 1 with a layer of powder 2 deposited on previously fused material 3 which sits on a build plate (not shown). An energy beam, such as laser beam 4 is scanned over the powder layer 2 and melts the powder layer to form a melt pool 5 which then solidifies to fuse the powder material to form a solidified layer 6 forming part of the component. Further layers are formed on top of the solidified layer 6 in the build direction Z to form the three dimensional component.

Components produced using ALM methods inevitably contain inherent residual stresses resulting from large thermal gradients between the melt pool 5 and the solidified layer 6 and the resulting rapid cooling of the material in the melt pool 5. To manage and minimise these stresses, cooling and hence solidification rates of the component during manufacture are controlled. Controlling the cooling rate can also help determine grain size in the solidified material and this, in turn can be used to tailor the mechanical properties of the component. For example, large grain sizes impart better creep resistance whilst smaller grain sizes give improved high and low cycle fatigue resistance.

Cooling rate can be controlled by heating the build chamber during manufacture to reduce local thermal gradients or by pre-heating the powder locally prior to fusing. It is also known to use a pulsed laser system to control the amount of energy input into the build layer during ALM.

However, such methods do not address the main problem associated with cracking, which is the large thermal gradient associated with the high intensity heat source provided by the laser and the high thermal gradients associated with rapid heating and cooling.

Grain orientation in the solid material is also important in determining mechanical properties of the component. In the known single beam systems shown in FIG. 1, the heat flux vector 7 is pointed directly away from the laser beam 4 as heat is conducted through the solidified material 3 towards the build plate. The grain growth vector 8 is in the opposite direction, and is the same in each layer. This results in high angle columnar grain boundaries in the build component which increases the likelihood of cracking.

There is a desire to provide a method that minimises residual stresses in components manufactured by ALM methods whilst ameliorating at least some of the problems associated with existing methods.

### SUMMARY

In a first aspect, the present invention provides a method of forming a three-dimensional component by additive layer manufacturing, said method including: scanning a fusing energy beam having a fusing beam focus spot across a layer of powered material in a series of fusing scan lines to fuse the powder material to form a layer of fused material whilst scanning a heating energy beam having a heating beam focus spot in a series of heating scan lines across the material fused by the fusing energy beam, wherein the centre of the fusing beam focus spot and the centre of the heating beam focus spot are off-set from one another and spaced by up to an amount equal to the sum of the radius (y) of the heating beam focus spot and two times the radius (x) of the fusing beam focus spot.

By off-setting the centres of the focus spots (such that they are not coincident) and spacing them by up to an amount equal to y+2x (where y is the radius of the heating beam focus spot and x is the radius of the fusing beam focus spot), the heating beam focus spot (which is located on the fused material previously fused by the fusing beam) abuts or overlaps the melt pool formed by the fusing beam (which is typically between 1.5 and 2 times the size of the fusing beam spot size). Accordingly, the heating beam focus spot heats the fused material adjacent the melt pool. Therefore, by scanning the heating energy beam (e.g. a laser or electron beam) over the layer of fused material whilst scanning the fusing energy beam (which may also be a laser or electron beam) in a series of scan lines over the layer of powdered material, it is possible the reduce the thermal gradient between the melted powder material in the melt pool and the adjacent fused material and thus reduce the cooling rate of the melted material. This results in a more uniform equiaxed grain structure in the fused material which, in turn reduces residual stresses and cracking in the resulting component. A reduction in the thermal gradient and residual stresses also reduce ductility drop cracking, which is believed to be an important crack forming mechanism in creep resistant nickel alloys built using ALM.

The reduction in cooling rate of the melted material also reduces the effects of surface tension-driven micro-segregation by reducing the thermal gradient in the melt pool and thus the convention that arises from the viscosity gradient within the melt pool. The effect is a reduction in the tendency for solidification cracking, as segregation is known to lead to fracture and stress relief cracking among other deleterious effects.

Furthermore, the offset heating beam focus spot alters the direction and magnitude of the heat flux vector and the grain growth vector. The principle cooling mechanism is still due to conduction through the fused material towards the build plate, but because of the heating by the heating energy beam, the heat flux vector is not pointed directly away from the fusing energy beam but is instead at an angle (less than 90°) to it. In turn, this means that the grain growth vector is also at an angle, anti-parallel to the heat flux vector which reduces high angle columnar grain boundaries in the build component which reduces the likelihood of cracking.

Optional features of the invention will now be set out. These are applicable singly or in any combination with any aspect of the invention.

The heating energy beam provides sufficient energy to heat the fused material but does not re-melt it. It may have a larger focus spot than the fusing beam focus spot.

The centres of the focus spots are off-set (with the centre of the heating beam focus spot positioned on the material previously fused by the fusing beam). In some embodiments, the centres of the focus spots are spaced by a minimum amount equal to y−x (where y and x are as defined above). In this embodiment, the heating beam focus spot will typically encompass the fusing beam focus spot (although they will not be coincident).

In some embodiments, the centres of the focus spots may be spaced by a maximum amount of about (x+y) (where x and y are as defined above). At this spacing the focus spots will abut one another.

In some embodiments, the fusing beam focus spot may be circular and may have a radius of between 25 and 125 microns.

In some embodiments, the heating beam focus spot may be circular or it may be elliptical and may have a radius between 2 to 4 times the radius of the fusing beam focus spot.

Where the heating beam focus spot is elliptical, the centre of the fusing beam focus spot will be aligned with the radius of the major (long) dimension of the elliptical heating beam focus spot and the radius y of the heating beam focus spot used to calculate the spacing between the centres of the focus spots will be in the major dimension.

The fusing scan lines may form any pattern over the powder material e.g. there may be a series of straight, parallel fusing scan lines extending across the entire of the layer of powder material or they may form an island or chequerboard pattern such as that shown in US2014/0154088. The heating scan lines will have the same pattern as the fusing scan lines and will extend either behind, ahead of or adjacent the fusing scan lines with at least a portion of the heating beam focus spot being on the material already fused by the fusing energy beam.

In some embodiments, the method may further comprise varying the angle of a vector extending between the centre of the fusing beam focus spot and the centre of the heating beam focus spot between two successive scan lines. In other words, the fusing energy beam and heating energy beam will both scan across their first respective fusing/heating scan line in a first angular relationship and then will scan across their second respective fusing/heating scan line in a second (different) angular relationship.

By changing the angular relation between the fusing beam focus spot and the heating beam focus spot between successive scan lines, the heat flux vector can be changed across the fused material layer. The grain growth vector is always directed anti-parallel to the heat flux vector. Changing the heat flux vector between successive scan lines produces a structure in which grains across the layer have a different orientation, disrupting epitaxial grain growth and texture of the microstructure.

The change in angular relationship is effected by adjusting the position of the heating beam focus spot relative to the fusing beams focus spot.

In some embodiments, the method may comprise varying the angle of the vector extending between the centres of the fusing beam focus spot and heating beam focus spot between zero and 180 degrees in increments, each increment being applied between successive fusing/heating scan lines. In some embodiments, the method may comprise varying the angle of the vector extending between the centres of the fusing beam focus spot and heating beam focus spot between 180 and zero degrees in increments, each increment being applied between successive fusing/heating scan lines.

Note that an angular relationship of zero degrees is where the vector is in the opposite direction to the fusing scan line (with the heating scan line effectively following the fusing scan line). An angular relationship of 180 degrees is where the vector is in the same direction as the fusing scan line (with the fusing scan line effectively following the heating scan line). An angular relationship of 90 degrees is where vector is perpendicular to the fusing scan line (with the heating and fusing scan lines adjacent and parallel).

In some embodiments, the method comprises varying the angle of the vector extending between the centres of the fusing beam focus spot and heating beam focus spot by ±90 degrees between successive scan lines.

In some embodiments, the method comprises varying the angle of the vector extending between the centres of the fusing beam focus spot and heating beam focus spot by ±135 degrees between successive scan lines.

In other words, the fusing energy beam and heating energy beam will both scan across their first respective fusing/heating scan lines in a first angular relationship and then will scan across their second respective fusing/heating scan lines in a second angular relationship, the first and second angular relationship differing by ±90 degrees or ±135 degrees. In some embodiments, where the vector extending between fusing beam focus spot and the heating beam focus spots is perpendicular (90 degrees) or 45 degrees to the fusing scan line in first fusing/heating scan lines, the method may comprise a first step of varying the angle of the vector extending between the centres of the fusing beam focus spot and heating beam focus spot by +90 degrees between first and second scan lines and a second step of varying the angle of the vector extending between the centres of the fusing beam focus spot and heating beam focus spot by −135 degrees between second and third scan lines.

In one embodiment, where the vector extending between fusing beam focus spot and the heating beam focus spots is at zero degrees to the fusing scan line in first fusing/heating scan lines, the method may include: a first step of varying the angle of the vector extending between the centres of the fusing beam focus spot and heating beam focus spot by +90 degrees between first and second scan lines (such that the heating beam focus spot is at 90 degrees to the fusing beam focus spot); a second step of varying the angle of the vector extending between the centres of the fusing beam focus spot and heating beam focus spot by +90 degrees between second and third scan lines (such that the heating beam focus spot is at 180 degrees to the fusing beam focus spot); a third step of varying the angle of the vector extending between the centres of the fusing beam focus spot and heating beam focus spot by −135 degrees between third and fourth scan lines (such that the heating beam focus spot is at 45 degrees to the fusing beam focus spot); a fourth step of varying the angle of the vector extending between the centres of the fusing beam focus spot and heating beam focus spot by +90 degrees between fourth and fifth scan lines (such that the heating beam focus spot is at 135 degrees to the fusing beam focus spot); and a fifth step of varying the angle of the vector extending between the centres of the fusing beam focus spot and heating beam focus spot by −135 degrees between fifth and sixth scan lines (such that the heating beam focus spot returns to zero degrees relative to the fusing beam focus spot). These steps may then be repeated.

In some embodiments, where the vector extending between fusing beam focus spot and the heating beam focus spots is at zero or 45 degrees to the fusing scan line in first fusing/heating scan lines, the method may comprise a first step of varying the angle of the vector extending between the centres of the fusing beam focus spot and heating beam focus spot by +135 degrees between first and second scan lines and a second step of varying the angle of the vector extending between the centres of the fusing beam focus spot and heating beam focus spot by −90 degrees between second and third scan lines.

In one embodiment, where the vector extending between fusing beam focus spot and the heating beam focus spots is at zero degrees to the fusing scan line in first fusing/heating scan lines, the method may include: a first step of varying the angle of the vector extending between the centres of the fusing beam focus spot and heating beam focus spot by +135 degrees between first and second scan lines (such that the heating beam focus spot is at 135 degrees to the fusing beam focus spot); a second step of varying the angle of the vector extending between the centres of the fusing beam focus spot and heating beam focus spot by −90 degrees between second and third scan lines (such that the heating beam focus spot is at 45 degrees to the fusing beam focus spot); a third step of varying the angle of the vector extending between the centres of the fusing beam focus spot and heating beam focus spot by +135 degrees between third and fourth scan lines (such that the heating beam focus spot is at 180 degrees to the fusing beam focus spot); a fourth step of varying the angle of the vector extending between the centres of the fusing beam focus spot and heating beam focus spot by −90 degrees between fourth and fifth scan lines (such that the heating beam focus spot is at 90 degrees to the fusing beam focus spot); and a fifth step of varying the angle of the vector extending between the centres of the fusing beam focus spot and heating beam focus spot by −90 degrees between fifth and sixth scan lines (such that the heating beam focus spot returns to zero degrees relative to the fusing beam focus spot). These steps may then be repeated. These series of steps maximise the angular variation between the grain orientation thus maximising the desirable isotropy.

In some embodiments, the method may further inlcude: forming a further layer of fused material by scanning the fusing energy beam across a further layer of fusible powder material in a further series of fusing scan lines whilst scanning the heating energy beam in a further series of heating scan lines across the further material fused by the fusing energy beam; and between forming the layer of fused material and the further layer of fused material, the method comprises varying the angle of a vector extending between the centre of the fusing beam focus spot and the centre of the heating beam focus spot.

In other words, the fusing energy beam and heating energy beam will both scan across their respective fusing/heating scan lines in a first (fixed) angular relationship to form the layer of fused material and then will scan across their respective fusing/heating scan lines in a second (different, fixed) angular relationship to form the further layer of fused material.

By changing the angular relation between the centre of the fusing beam focus spot and the centre of the heating beam focus spot between successive layers, the heat flux vector can be changed between layers. The grain growth vector is always directed anti-parallel to the heat flux vector. Changing the heat flux vector between successive build layers produces a layered structure in which grains in successive layers have a different orientation, disrupting epitaxial grain growth and texture of the microstructure. This, in turn, reduces internal stresses caused by the high angle columnar grain boundaries and thus cracking/fracture in the resulting component.

In some embodiments, the method comprises varying the angle of the vector extending between the fusing beam focus spot and the heating beam focus by 90 or 135 degrees between forming the layer of fused material and the further layer of fused material. In other words, the fusing energy beam and heating energy beam will both scan across their respective fusing/heating scan lines in a first angular relationship to form the layer of fused material and then will scan across their respective fusing/heating scan lines in a second angular relationship, the first and second angular relationship differing by 90 degrees or 135 degrees.

The method may comprise varying the orientation of the fusing and heating scan lines between the formation of the layer of fused material and the further layer of fused material e.g. by rotation, for example by rotation through 67 degrees.

The method may comprise modulating the heating energy beam. The slower cooling rate of the melted powder material results in the formation of cellular dendrite structures in the fused material. Modulation of the heating energy beam leads to vibration of the fused material thus fracturing the cellular dendrite microstructure and promoting secondary nucleation of grains with a random dendritic orientation.

In some embodiments, the method includes heating the or each layer of fusible powder material prior to and/or during scanning by the fusing energy beam. The fusible powder could be heating using resistance or induction heating for example.

In some embodiments, the three-dimensional component is heat-treated after manufacture e.g. using HIP, annealing or precipitation hardening.

In some embodiments, the method comprises forming the three dimensional component using selective laser melting (SLM) or selective laser sintering (SLS).

In some embodiments, the method comprises forming a hot gas path component for a gas turbine. For example, the method could comprise forming a combustor liner, a seal segment, a nozzle guide vane, a pre-swirl nozzle, an OGV ring or a turbine blade.

In some embodiments the powder material may be formed of metal or metal alloy e.g. from nickel, copper, iron, steel, nickel alloys, titanium, titanium alloys, magnesium, magnesium alloys, aluminium, aluminium alloys, vanadium, zirconium, hafnium, or refractory metals such as niobium, molybdenum, tantalum, tungsten and rhenium. The powder material may be a metal matrix composite or intermetallic such as TiAl or NiAl. In particular, the powder material may be a powdered super-alloy, such as a nickel-based super alloys such as MARM002, CM247LC or IN738.

In a second aspect, the present invention provides an apparatus for forming a three-dimensional component by additive layer manufacturing, said apparatus including: a fusing energy beam generator adapted to generate a fusing energy beam having a fusing beam focus spot; a heating energy beam generator adapted to generate a heating energy beam having a heating beam focus spot wherein the fusing beam focus spot is smaller in diameter than the heating beam focus spot, wherein the fusing energy beam generator is adapted to scan the fusing energy beam across a layer of powdered material in a series of fusing scan lines to fuse the powder material to form a layer of fused material whilst the heating energy beam generator is adapted to scan the heating energy beam in a series of heating scan lines across the material fused by the fusing energy beam such that the centre of the fusing beam focus spot and the centre of the heating beam focus spot are off-set from one another and spaced by up to an amount equal to the sum of the radius (y) of the heating beam focus spot and two times the radius (x) of the fusing beam focus spot.

In some embodiments, the fusing energy beam generator and heating energy beam generator are adapted to produce the fusing energy beam and heating energy beam such that centres of the focus spots are spaced by a minimum amount equal to y−x (where y and x are as defined above). In this embodiment, the heating beam focus spot will typically encompass the fusing beam focus spot (although they will not be coincident).

In some embodiments, the fusing energy beam generator and heating energy beam generator are adapted to produce the fusing energy beam and heating energy beam such that centres of the focus spots are spaced by a maximum amount equal to x+y (where y and x are as defined above). At this spacing the focus spots will abut one another.

In some embodiments, the fusing energy beam generator may be adapted to generate a fusing beam focus spot which is circular and may have a radius of between 25 and 125 microns.

In some embodiments, the heating energy beam generator may be adapted to generate a heating beam focus spot which is circular or elliptical and may have a radius between 2 to 4 times the radius of the fusing beam focus spot.

Where the heating energy beam generator is adapted to generate an elliptical heating beam focus spot, the fusing energy beam generator is adapted to generate the centre of the fusing beam focus spot aligned with the radius of the major (long) dimension of the elliptical heating beam focus spot and the radius y of the heating beam focus spot used to calculate the spacing between the centres of the focus spots will be in the major dimension.

In some embodiments, the fusing energy beam generator is adapted to scan the fusing energy beam in a series of fusing scan lines which may form any pattern over the powder material e.g. it may be adapted to scan the fusing energy beam in a series of straight, parallel fusing scan lines extending across the entire of the layer of powder material or in a series of lines that form an island or chequerboard pattern such as that shown in US2014/0154088. The heating energy beam generator will be adapted to scan the heating energy beam in a series of heating scan lines which will have the same pattern as the fusing scan lines and will extend either behind, ahead of or adjacent the fusing scan lines with at least a portion of the heating beam focus spot being on the material already fused by the fusing energy beam.

In some embodiments, the heating energy beam generator may be adapted to vary the angle of a vector extending between the centre of the fusing beam focus spot and the heating beam focus spot between two successive scan lines or between the formation of successive layers of fused material.

In order to effect the change in angular relationship, the heating energy beam generator may be adapted to adjusting the position of the heating beam focus spot relative to the fusing beams focus spot.

In some embodiments, the heating beam generator may be adapted to vary the angle of the vector extending between the centres of the fusing beam focus spot and heating beam focus spot between zero and 180 degrees in increments, each increment being applied between successive fusing/heating scan lines. In some embodiments, the heating beam generator may be adapted to vary the angle of the vector extending between the centres of the fusing beam focus spot and heating beam focus spot between 180 and zero degrees in increments, each increment being applied between successive fusing/heating scan lines.

In some embodiments, the heating beam generator may be adapted to vary the angle of the vector extending between the centres of the fusing beam focus spot and heating beam focus spot by ±90 degrees between successive scan lines.

In some embodiments, the heating beam generator may be adapted to vary the angle of the vector extending between the centres of the fusing beam focus spot and heating beam focus spot by ±135 degrees between successive scan lines. The heating beam generator may be adapted to modulate the heating energy beam by pulsing the heating energy beam.

The apparatus may further comprise a heater e.g. an induction heater or a resistance heater for heating the fusible powdered material.

### BRIEF DESCRIPTION OF THE DRAWINGS

Embodiments of the invention will now be described by way of example with reference to the accompanying drawings in which:

FIG. 1 shows a side view of a standard prior art single beam ALM system;

FIG. 2 shows a side view of first embodiment of the present invention;

FIG. 3 shows a top view of the first embodiment of the present invention;

FIG. 4 shows a second, alternative spacing of the focus spot;

FIG. 5 shows a third, alternative spacing of the focus spots;

FIG. 6 shows a fourth, alternative spacing of the focus spots with an elliptical heating beam focus spot; and

FIG. 7 shows a schematic representation of the angular variation between the fusing energy beam and heating energy beam.

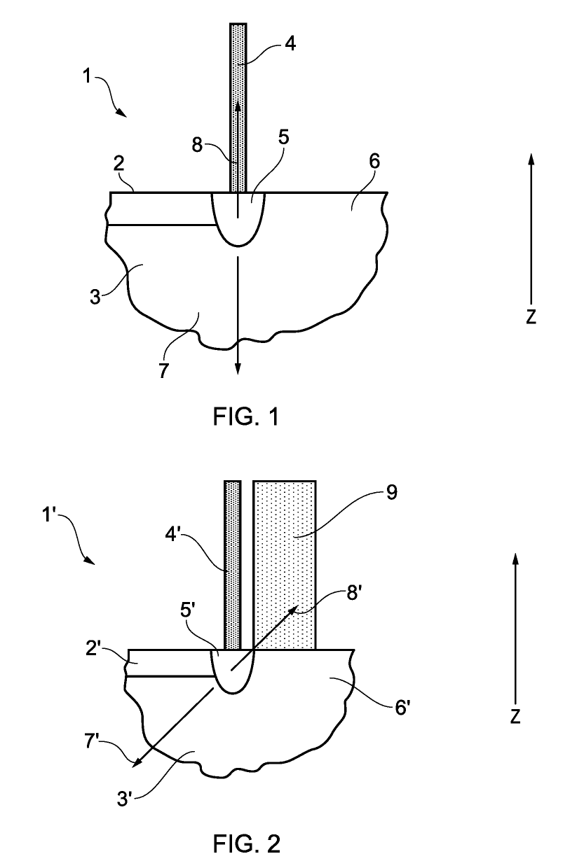

### DETAILED DESCRIPTION

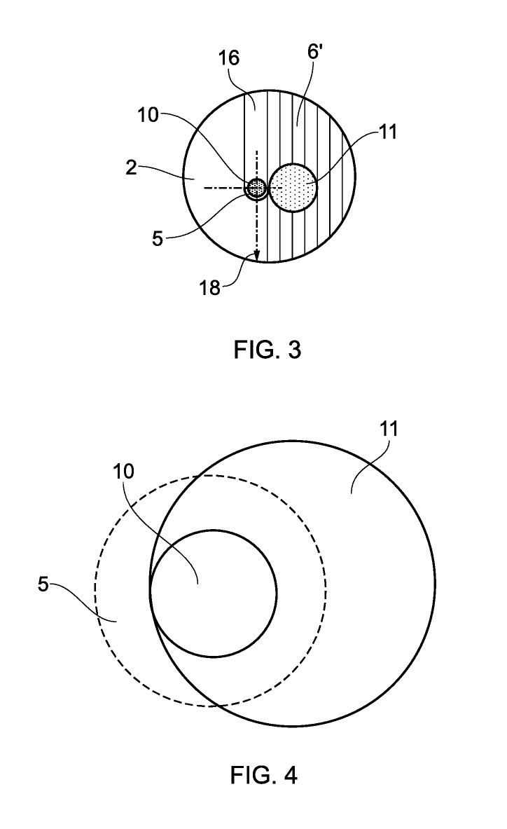

FIGS. 2 and 3 show side and top views of an additive layer manufacturing apparatus/method according to a first embodiment of the present invention with a layer 2′ of powder material (such as a powdered nickel based super alloy) deposited on previously fused material 3′ which sits on a build plate (not shown).

A fusing energy beam, such as laser beam 4′ is provided and is focussed on the powder layer 2′ and melts the powder layer to form a melt pool 5′ of melted material which then solidifies to fuse the powder material to form a layer of fused material layer 6′ forming part of the component (together with the fused material 3′). The fusing energy laser beam 4′ is scanned across the powder layer 2′ in a series of fusing scan lines.

A heating energy beam such as laser beam 9 is also provided. The heating energy beam 9 is modulated. This is scanned across the fused material layer 6′ simultaneously with the fusing energy beam 4′. As shown in FIG. 3, the fusing beam focus spot 10 is smaller in diameter than the heating beam focus spot 11.

The fusing beam focus spot 10 and the heating beam focus spot 11 are off set from one another and spaced by an amount equal to the sum of the radii of the focus spots 10, 11 such that the circumference of the heating beam focus spot 11 abuts the melt pool 5 of melted material formed by the fusing energy beam 4′.

Alternative embodiments are shown in FIGS. 4-6.

In FIG. 4, the fusing beam focus spot 10 and the heating beam focus spot 11 are spaced by an amount equal to y−x where y is the radius of the heating beam spot and x is the radius of the fusing beam spot. In this embodiment, the fusing beam focus spot is within the heating beam focus spot (but not coincident with it).

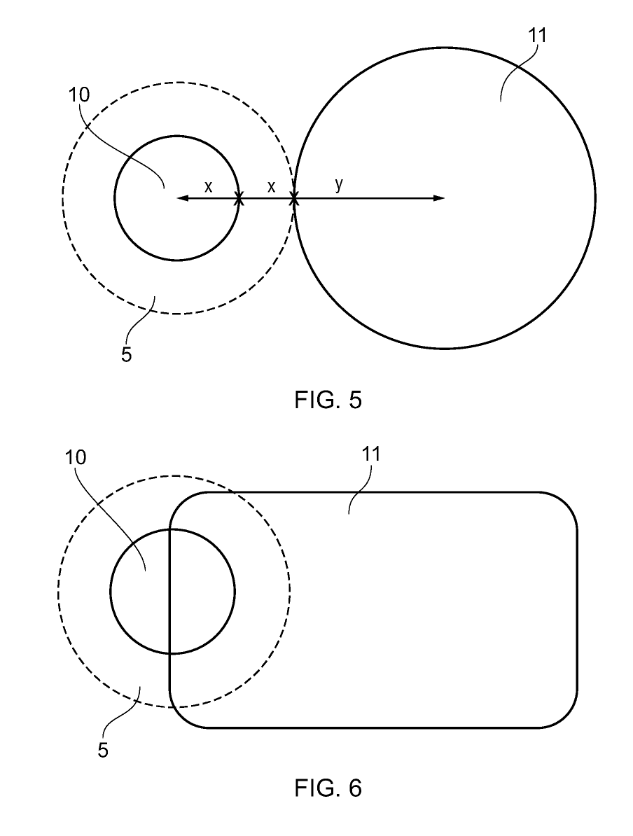

In FIG. 5, the fusing beam focus spot 10 and the heating beam focus spot 11 are spaced by an amount equal to y+2x where y is the radius of the heating beam spot and x is the radius of the fusing beam spot. In this embodiment, the heating beam focus spot abuts the melt pool 5 created around the heating beam focus spot.

In FIG. 6, the heating beam focus spot is elliptical and the fusing beam focus spot 10 and the heating beam focus spot 11 are spaced by an amount greater than y−x where y is the major radius of the heating beam spot and x is the radius of the fusing beam spot. In this embodiment, the fusing beam focus spot and the heating beam focus spot overlap.

By off-setting the centres of the focus spots 10, 11 and spacing them by up to an amount equal to the sum of the radius of the heating beam focus spot 11 and two times the radius of the fusing beam focus spot 10, the heating beam focus spot 11 abuts or overlaps the melt pool 5 formed by the fusing beam 4′ (which is typically between 1.5 and 2 times the size of the fusing beam spot size).

By scanning the heating energy beam 9 over the fused material 6′ whilst scanning the fusing energy beam 4′ in a series of scan lines over the powder layer 2′,it is possible the reduce the thermal gradient between the melted material and the fused material layer 6′ and thus reduce the cooling rate of the melted material. This results in a more uniform equiaxed grain structure in the fused material 3′ which, in turn reduces residual stresses and cracking in the resulting component. A reduction in the thermal gradient and residual stresses also reduce ductility drop cracking.

Furthermore, the heating energy beam 9 alters the direction and magnitude of the heat flux vector 7′ and the grain growth vector 8′. The principle cooling mechanism is still due to conduction through the fused material 3 towards the build plate, but because of heating by the heating energy beam 9 the heat flux vector 7′ is not aligned directly away from the fusing energy beam 4′ but is instead at an angle (less than 90°) to it. In turn, this means that the grain growth vector 8′ is also at an angle, anti-parallel to the heat flux vector 7′ which reduces high angle columnar grain boundaries in the build component which reduces the likelihood of cracking.

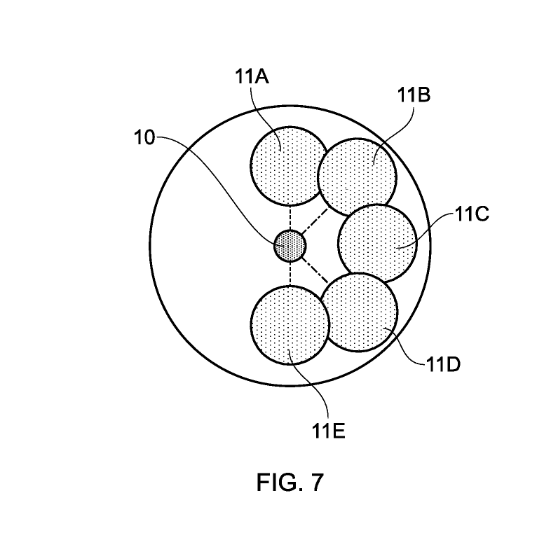

FIG. 7 shows a schematic representation of the relative positioning of the heating beam focus spot 11A-11E and the fusing beam focus spot 10 during successive scan lines.

Initially the vector extending between fusing beam focus spot 10 and the heating beam focus spot 11A is at zero degrees to the fusing scan line. Between the first and second scan lines, the angle of the vector is varied by +90 degrees (such that the heating beam focus spot 11C is at 90 degrees to the fusing beam focus spot 10. Next, the angle of the vector is varied by +90 degrees between second and third scan lines (such that the heating beam focus spot 11E is at 180 degrees to the fusing beam focus spot 10). Between the third and fourth scan lines, the angle of the vector is varied by −135 degrees (such that the heating beam focus spot 11B is at 45 degrees to the fusing beam focus spot 10. Next, the angle of the vector is varied by +90 degrees between fourth and fifth scan lines (such that the heating beam focus spot 11D is at 135 degrees to the fusing beam focus spot 10) and, finally, the angle of vector the vector is varied by −135 degrees between fifth and sixth scan lines (such that the heating beam focus spot 11A returns to zero degrees relative to the fusing beam focus spot 10

These steps may then be repeated.

By changing the angular relation between the fusing beam focus spot 10 and the heating beam focus spot (11A-11E) between successive scan lines, the heat flux vector 7′ can be changed across the layer of used material 6′. The grain growth vector 8′ is always directed anti-parallel to the heat flux vector 7′. Changing the heat flux vector 7′ between successive scan lines produces a structure in which grains have a different orientation, disrupting epitaxial grain growth and texture of the microstructure. This, in turn, reduces internal stresses caused by the high angle columnar grain boundaries and thus cracking/fracture in the resulting component.

In order to build up the component, multiple layers are built as described above one upon another in the build direction Z. The orientation of the fusing scan lines may be changed by 67 degrees between successive layers.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the scope of the invention.

1. A method of forming a three-dimensional component by additive layer manufacturing, said method comprising:
scanning a fusing energy beam having a fusing beam focus spot across a layer of powdered material in a series of fusing scan lines to fuse the powder material to form a layer of fused material whilst scanning a heating energy beam having a heating beam focus spot in a series of heating scan lines across the material fused by the fusing energy beam,
wherein the centre of the fusing beam focus spot and the centre of the heating beam focus spot are off-set from one another and spaced by up to an amount equal to the sum of the radius (y) of the heating beam focus spot and two times the radius (x) of the fusing beam focus spot.

2. A method according to claim 1 wherein the centres of the focus spots are spaced by a minimum amount equal to y−x (where y and x are as defined above).

3. A method according to claim 1 wherein the centres of the focus spots are spaced by a maximum amount of x+y (where x and y are as described above).

4. A method according to claim 1 further comprising varying the angle of a vector extending between the centre of the fusing beam focus spot and the centre of the heating beam focus spot between two successive scan lines.

5. A method according to claim 4 comprising varying the angle of the vector extending between the centres of the fusing beam focus spot and heating beam focus spot between zero and 180 degrees in increments, each increment being applied between successive fusing/heating scan lines and/or varying the angle of the vector extending between the centres of the fusing beam focus spot and heating beam focus spot between 180 and zero degrees in increments, each increment being applied between successive fusing/heating scan lines.

6. A method according to claim 4 wherein, when the vector extending between fusing beam focus spot and the heating beam focus spots is perpendicular (90 degrees) or 45 degrees to the fusing scan line in first fusing/heating scan lines, the method comprises a first step of varying the angle of the vector extending between the centres of the fusing beam focus spot and heating beam focus spot by +90 degrees between first and second scan lines and a second step of varying the angle of the vector extending between the centres of the fusing beam focus spot and heating beam focus spot by −135 degrees between second and third scan lines.

7. A method according to claim 4 wherein, when the vector extending between fusing beam focus spot and the heating beam focus spots is at zero degrees to the fusing scan line in first fusing/heating scan lines, the method comprises:
a first step of varying the angle of the vector extending between the centres of the fusing beam focus spot and heating beam focus spot by +90 degrees between first and second scan lines;
a second step of varying the angle of the vector extending between the centres of the fusing beam focus spot and heating beam focus spot by +90 degrees between second and third scan lines;
a third step of varying the angle of the vector extending between the centres of the fusing beam focus spot and heating beam focus spot by −135 degrees between third and fourth scan lines;
a fourth step of varying the angle of the vector extending between the centres of the fusing beam focus spot and heating beam focus spot by +90 degrees between fourth and fifth scan lines; and
a fifth step of varying the angle of the vector extending between the centres of the fusing beam focus spot and heating beam focus spot by −135 degrees between fifth and sixth scan lines.

8. A method according to claim 4 wherein, when the vector extending between fusing beam focus spot and the heating beam focus spots is at zero or 45 degrees to the fusing scan line in first fusing/heating scan lines, the method comprises a first step of varying the angle of the vector extending between the centres of the fusing beam focus spot and heating beam focus spot by +135 degrees between first and second scan lines and a second step of varying the angle of the vector extending between the centres of the fusing beam focus spot and heating beam focus spot by −90 degrees between second and third scan lines.

9. A method according to claim 4 wherein, when the vector extending between fusing beam focus spot and the heating beam focus spots is at zero degrees to the fusing scan line in first fusing/heating scan lines, the method comprises:
a first step of varying the angle of the vector extending between the centres of the fusing beam focus spot and heating beam focus spot by +135 degrees between first and second scan lines;
a second step of varying the angle of the vector extending between the centres of the fusing beam focus spot and heating beam focus spot by −90 degrees between second and third scan lines;
a third step of varying the angle of the vector extending between the centres of the fusing beam focus spot and heating beam focus spot by +135 degrees between third and fourth scan lines;
a fourth step of varying the angle of the vector extending between the centres of the fusing beam focus spot and heating beam focus spot by −90 degrees between fourth and fifth scan lines; and
a fifth step of varying the angle of the vector extending between the centres of the fusing beam focus spot and heating beam focus spot by −90 degrees between fifth and sixth scan lines.

10. A method according to claim 1 comprising:
forming a further layer of fused material by scanning the fusing energy beam across a further layer of fusible powder material in a further series of fusing scan lines whilst scanning the heating energy beam in a further series of heating scan lines across the further material fused by the fusing energy beam; and
between forming the layer of fused material and the further layer of fused material, the method comprises varying the angle of a vector extending between the centre of the fusing beam focus spot and the centre of the heating beam focus spot.

11. An apparatus for forming a three-dimensional component by additive layer manufacturing, said apparatus comprising:
a fusing energy beam generator adapted to generate a fusing energy beam having a fusing beam focus spot;
a heating energy beam generator adapted to generate a heating energy beam having a heating beam focus spot,
wherein the fusing energy beam generator is adapted to scan the fusing energy beam across a layer of powdered material in a series of fusing scan lines to fuse the powder material to form a layer of fused material whilst the heating energy beam generator is adapted to scan the heating energy beam in a series of heating scan lines across the material fused by the fusing energy beam such that the centre of the fusing beam focus spot and the centre of the heating beam focus spot are off-set from one another and spaced by up to an amount equal to the sum of the radius (y) of the heating beam focus spot and two times the radius (x) of the fusing beam focus spot.

12. Apparatus according to claim 11 wherein the fusing energy beam generator and heating energy beam generator are adapted to produce the fusing energy beam and heating energy beam such that centres of the focus spots are spaced by a minimum amount equal to y−x (where y and x are as defined above).

13. Apparatus according to claim 11 wherein the fusing energy beam generator and heating energy beam generator are adapted to produce the fusing energy beam and heating energy beam such that centres of the focus spots are spaced by a maximum amount equal to x +y (where y and x are as defined above).

14. Apparatus according to claim 11 wherein the heating energy beam generator is adapted to vary the angle of a vector extending between the centre of the fusing beam focus spot and the heating beam focus spot between two successive scan lines or between the formation of successive layers of fused material.

15. An apparatus according to claim 11 wherein the heating beam generator is adapted to modulate the heating energy beam by pulsing the heating energy beam.
